(19) United States
(12) Patent Application Publication
(10) Pub. No.: US 2020/0377366 A1
(43) Pub. Date: Dec. 3, 2020

(54) HYDROGEN IODIDE (HI) PRODUCTION BY REACTION OF HYDROGEN (H2) WITH IODINE (I2) DISSOLVED IN A SOLVENT

(71) Applicant: Honeywell International Inc., Morris Plains, NJ (US)

(72) Inventors: Haridasan K. Nair, Williamsville, NY (US); Ryan J. Hulse, Getzville, NY (US)

(21) Appl. No.: 16/887,225

(22) Filed: May 29, 2020

Related U.S. Application Data
(60) Provisional application No. 62/856,243, filed on Jun. 3, 2019.

(51) Int. Cl. C01B 7/13

(52) U.S. Cl. CPC C01B 7/135

(57) ABSTRACT

A process for the manufacture of hydrogen iodide (HI) from hydrogen (H₂) and elemental iodine (I₂) dissolved in a suitable solvent with use of at least one catalyst selected from the group of platinum, palladium, nickel, cobalt, iron, nickel oxide, cobalt oxide, and iron oxide.

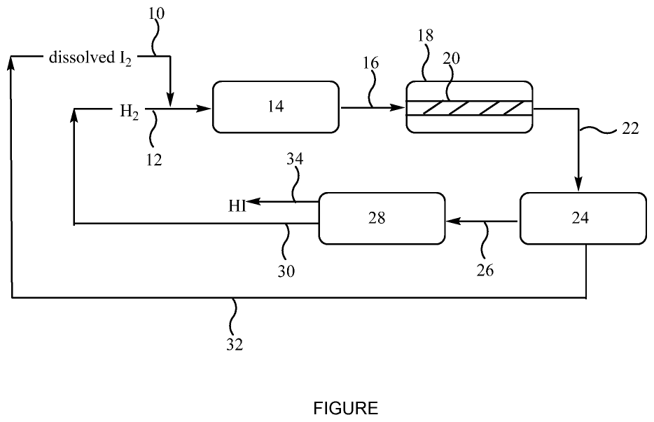

### CROSS-REFERENCE TO RELATED APPLICATION

This application claims priority to Provisional Application No. 62/856,243, filed Jun. 3, 2019, which is herein incorporated by reference in its entirety.

### TECHNICAL FIELD

This disclosure described is a process for making hydrogen iodide (HI) using iodine and hydrogen. Specifically, the present disclosure relates to a process for producing hydrogen iodide from hydrogen and dissolved iodine in the presence of a catalyst.

### BACKGROUND

Hydrogen iodide is an important industrial chemical used as a reducing agent, as well as in the preparation of hydroiodic acid, organic and inorganic iodides, and iodoalkanes. However, hydrogen iodide is very difficult to handle due to its instability and reactivity. For example, hydrogen iodide decomposes in the presence of heat or light to form hydrogen and iodine. Additionally, in the presence of moisture, hydrogen iodide forms hydroiodic acid which can corrode most metals. The instability and reactivity of hydrogen iodide makes it hard to store and to transport. As such, anhydrous hydrogen iodide is often prepared locally for immediate use.

Various methods have been reported for making hydrogen iodide. See, for example, N. N. Greenwood et al., The Chemistry of the Elements, 2nd edition, Oxford: Butterworth-Heineman, p 809-815, 1997, in which hydrogen iodide is prepared from the reaction of elemental iodine with hydrazine according to Equation 1 below:

2I₂+N₂H₄→4HI+N₂ Eq. 1:

In another example, in Textbook of Practical Organic Chemistry, 3rd edition, A. I. Vogel teaches that hydrogen iodide can be prepared by reacting a stream of hydrogen sulfide with iodine according to Equation 2 below:

H₂S+I₂→2HI+S Eq. 2:

Each of the above examples use costly starting materials, such as hydrogen sulfide or hydrazine, that restrict their application for large scale, economical preparation of hydrogen iodide. Additionally, the use of hydrazine for preparation of hydrogen iodide results in the formation of nitrogen gas as a byproduct. Separation of the nitrogen gas from the hydrogen iodide to purify the hydrogen iodide is difficult and expensive, thus adding to manufacturing costs. Similarly, the use of hydrogen sulfide results in the formation of sulfur, which is difficult to separate from unreacted iodine, again adding to manufacturing costs. Sulfur may poison any catalysts used, further adding to manufacturing costs.

In some other examples, gaseous hydrogen iodide is prepared from elemental iodine and hydrogen gas, according to Equation 3 below:

H₂+I₂→2HI Eq. 3:

For example, U.S. Pat. No. 3,154,382 describes the use of molten iodide or an aqueous solution of iodide in conjunction with hydrogen gas to prepare hydrogen iodide. U.S. Pat. No. 8,268,284 B2 also discloses the use of elemental iodine to prepare hydrogen iodide, where solid iodine is first melted and then vaporized to permit the gas phase reaction with hydrogen.

As exemplified by the foregoing references, solid iodine may present difficulties in its use as a staring material, as it is challenging to create a gaseous feed stream to a reactor from solid iodine, and the use of iodine vapor poses further difficulties due to clogging of reactor parts as vaporized iodine re-condenses.

### SUMMARY

The present disclosure provides a process for the manufacture of hydrogen iodide (HI) from hydrogen (H₂) and elemental iodine (I₂) dissolved in a suitable solvent with use of at least one catalyst selected from the group of platinum, palladium, nickel, cobalt, iron, nickel oxide, cobalt oxide, and iron oxide.

The present disclosure provides a process for producing hydrogen iodide, including providing a reactant stream comprising hydrogen (H₂) and iodine (I₂), the iodine dissolved in a suitable solvent which can be conveniently fed into a reactor by a liquid pump, unlike the inherent difficulties involved in addition of solid/gaseous iodine to a reactor, and reacting the reactant stream in the presence of a catalyst to produce a product stream comprising hydrogen iodide.

The solvent may include at least one solvent selected from the group consisting of ethers, such as diethyl ether and diglyme; nitriles, such as benzonitrile and acetonitrile; formamides, such as dimethylformamide; ionic liquids, such as 1-ethyl-3-methylimidazolium acetate; sulfolane; carbon disulfide; toluene; naphthalene; xylene; 2,2-dimethylbutane; cyclohexane; acetone; ethanol; perfluoroheptane; and mesitylene.

The catalyst may include at least one catalyst selected from the group consisting of platinum, palladium, nickel, cobalt, iron, nickel oxide, cobalt oxide, and iron oxide.

### BRIEF DESCRIPTION OF THE DRAWING

The FIGURE is a process flow diagram showing a process for manufacturing hydrogen iodide (HI).

### DETAILED DESCRIPTION

The present disclosure provides a process for the manufacture of hydrogen iodide (HI) from hydrogen (H₂) and elemental iodine (I₂) dissolved in a suitable solvent in the presence of at least one catalyst such as platinum, palladium, nickel, cobalt, iron, nickel oxide, cobalt oxide, and iron oxide.

As disclosed herein, the hydrogen iodide is produced from a reactant stream comprising hydrogen (H₂), iodine (I₂), and a suitable solvent.

The solvent is used for dissolving the iodine to facilitate easier handling of the iodine as a reactant and to promote reliable conveying of the iodine to the reactor for reacting with the hydrogen. The dissolved iodine may be blended with hydrogen upstream of the reactor, or the dissolved iodine may be conveyed directly into the reactor for reactive contact with the hydrogen in the reactor.

Suitable solvents for the iodine, which may also be the solvent for the reaction of iodine with hydrogen, may have a boiling point greater than 100° C., greater than 125° C., or greater than 150° C., for example, and are stable under the elevated temperature reaction conditions and are non-reactive when exposed to the reagents, products, and catalysts present in the reaction.

The solvent may be capable of dissolving at least about 5 weight percent (wt. %), at least about 10 wt. %, at least about 15 wt. %, at least about 20 wt. %, or at least about 25 wt. % iodine (I₂). The weight percent measurement is defined as the ratio of the mass of the solute to the total mass of the solute/solvent mixture. For example, in a 20 wt. % solution of iodine (I₂), 100 grams of solution contains 20 grams of iodine (I₂).

The solvent may be selected from ethers, such as diethyl ether and diglyme; nitriles, such as benzonitrile and acetonitrile; and formamides, such as dimethylformamide; ketones, such as acetone; ionic liquids, such as 1-ethyl-3-methylimidazolium acetate; sulfolane; carbon disulfide; toluene; naphthalene; xylene; 2,2-dimethylbutane; cyclohexane; ethanol; perfluoroheptane; mesitylene; carbon tetrachloride; 1,1-dichloroethene; and alkanes. The iodine (I₂) is provided to the reactor dissolved in a solvent. The dissolved iodine may be blended with hydrogen upstream of the reactor and co-fed to the reactor. Alternatively, the dissolved iodine may be conveyed directly into the reactor for reactive contact with the hydrogen in the reactor.

The solvent in which the iodine (I₂) is dissolved is selected from at least one of ethers, such as diethyl ether and diglyme; nitriles, such as benzonitrile and acetonitrile; and formamides, such as dimethylformamide; ionic liquids, such as 1-ethyl-3-methylimidazolium acetate; sulfolane; carbon disulfide; toluene; naphthalene; xylene; 2,2-dimethylbutane; cyclohexane; ethanol; perfluoroheptane; and mesitylene.

The following table gives approximate solubility of iodine in some of the solvents. Different solvents—ethers, such as diethyl ether and diglyme; nitriles, such as benzonitrile and acetonitrile; and formamides, such as dimethylformamide; ionic liquids, such as 1-ethyl-3-methylimidazolium acetate; sulfolane; carbon disulfide; toluene; naphthalene; xylene; 2,2-dimethylbutane; cyclohexane; ethanol; perfluoroheptane; and mesitylene were tested. Thermally stable solvents (vapor decomposition temperature >500° C.) such as toluene, benzonitrile, naphthalene may also be used, and can be recycled.

TABLE 1
Approximate solubility of iodine (I₂) in various solvents

| Solvent | Weight % Iodine (I₂) |
|---|---|
| Dimethylformamide (DMF) | 9-38 |
| Diglyme | 9-33 |
| Dimethyl sulfoxide (DMSO) | 9-38 |
| Acetonitrile | ~9 |
| Sulfolane | ~5 |
| Carbon disulfide | 16.49 |
| 2,2-Dimethylbutane | 1.37 |
| Cyclohexane | 2.70 |
| Ethanol | 21.40 |
| Ethyl ether | 25.10 |
| p-Xylene | 16.56 |
| Mesitylene | 20.27 |
| Perfluoroheptane | 0.012 |
| 1-Ethyl-3-methylimidazolium acetate | 9-38 |

The hydrogen, iodine, and solvent may be anhydrous. It is preferred that there be as little water in the reactant stream as possible because the presence of moisture results in the formation of hydroiodic acid, which is corrosive and can be detrimental to downstream equipment and process lines. In addition, recovery of the hydrogen iodide from the hydroiodic acid adds to the manufacturing costs.

The hydrogen may be substantially free of water, including any water by weight in an amount less than about 500 ppm, about 300 ppm, about 200 ppm, about 100 ppm, about 50 ppm, about 30 ppm, about 20 ppm, 10 ppm, or about 5 ppm, or less than any value defined between any two of the foregoing values. Preferably, the hydrogen comprises any water by weight in an amount less than about 50 ppm. More preferably, the hydrogen comprises any water by weight in an amount less than about 10 ppm. Most preferably, the hydrogen comprises any water by weight in an amount less than about 5 ppm.

The iodine may also be substantially free of water, including any water by weight in an amount less than about 500 ppm, about 300 ppm, about 200 ppm, about 100 ppm, about 50 ppm, about 30 ppm, about 20 ppm, or about 10 ppm, or less than any value defined between any two of the foregoing values. Preferably, the iodine comprises any water by weight in an amount less than about 100 ppm. More preferably, the iodine comprises any water by weight in an amount less than about 30 ppm. Most preferably, the iodine comprises any water by weight in an amount less than about 10 ppm.

The solvent may also be substantially free of water, including any water by weight in an amount less than about 500 ppm, about 300 ppm, about 200 ppm, about 100 ppm, about 50 ppm, about 30 ppm, about 20 ppm, 10 ppm, or about 5 ppm, or less than any value defined between any two of the foregoing values. Preferably, the solvent comprises any water by weight in an amount less than about 50 ppm. More preferably, the solvent comprises any water by weight in an amount less than about 10 ppm. Most preferably, the solvent comprises any water by weight in an amount less than about 5 ppm.

Elemental iodine in solid form is commercially available from, for example, SQM, Santiago, Chile, or Kanto Natural Gas Development Co., Ltd, Chiba, Japan. Hydrogen in compressed gas form is commercially available from, for example, Airgas, Radnor, Pa.

In the reactant stream, a mole ratio of hydrogen to iodine may be as low as about 1:1, about 1.5:1, about 2:1, about 2.5:1, about 2.7:1, or about 3:1, or as high as about 4:1, about 5:1, about 6:1, about 7:1, about 8:1, about 9:1, or about 10:1, or within any range defined between any two of the foregoing values, such as about 1:1 to about 10:1, about 2:1 to about 8:1, about 3:1 to about 6:1, about 2:1 to about 5:1, about 2:1 to about 3:1, about 2.5:1 to about 3:1, or about 2.7:1 to about 3.0:1, for example. Preferably, the mole ratio of hydrogen to iodine is from about 2:1 to about 5:1. More preferably, the mole ratio of hydrogen to iodine is from about 2:1 to about 3:1. Most preferably, the mole ratio of hydrogen to iodine is from about 2.5:1 to 3:1.

The reactant stream, including iodine dissolved in the solvent and hydrogen, reacts in the presence of a catalyst contained within a reactor to produce a product stream comprising hydrogen iodide according to Equation 3 above. The reactor may be a heated tube reactor, such as a fixed bed tubular reactor, including a tube containing the catalyst. The tube may be made of a metal such as stainless steel, nickel, a nickel alloy, such as a nickel-chromium alloy, a nickel-molybdenum alloy, a nickel-chromium-molybdenum alloy, a nickel-iron-chromium alloy, or a nickel-copper alloy. The tube reactor is heated, thus also heating the catalyst. Alternatively, the reactor may be any type of packed reactor.

As noted above, the catalyst is a platinum, palladium, nickel, cobalt, iron, nickel oxide, cobalt oxide, and iron oxide catalyst. The catalyst may be supported on a support. Thus, the catalyst comprises at least one selected from the group of platinum, palladium, nickel, cobalt, iron, nickel oxide, cobalt oxide, and iron oxide, wherein the catalyst is supported on a support. The support can be selected from the group of activated carbon, silica gel, zeolite, silicon carbide, metal oxides, and combinations thereof. Non-exclusive examples of the metal oxides include alumina, magnesium oxide, titanium oxide, zinc oxide, zirconia, chromia, and combinations thereof.

The catalyst can comprise platinum on a metal oxide support. The catalyst can consist essentially of platinum on a metal oxide support. The catalyst can consist of platinum on a metal oxide support. The catalyst can comprise platinum on an alumina support. The catalyst can comprise platinum on an activated carbon support. The catalyst can consist essentially of platinum on an activated carbon support. The catalyst can consist of platinum on an activated carbon support.

The catalyst can comprise palladium on a metal oxide support. The catalyst can consist essentially of palladium on a metal oxide support. The catalyst can consist of palladium on a metal oxide support. The catalyst can comprise palladium on an alumina support. The catalyst can comprise palladium on an activated carbon support. The catalyst can consist essentially of palladium on an activated carbon support. The catalyst can consist of palladium on an activated carbon support.

The catalyst can comprise nickel on a silica gel support. The catalyst can comprise nickel on a zeolite support. The catalyst can comprise nickel on an activated carbon support. The catalyst can comprise nickel on a silicon carbide support. The catalyst can consist essentially of nickel on a silica gel support. The catalyst can consist essentially of nickel on a zeolite support. The catalyst can consist essentially of nickel on an activated carbon support. The catalyst can consist essentially of nickel on a silicon carbide support. The catalyst can consist of nickel on a silica gel support. The catalyst can consist of nickel on a zeolite support. The catalyst can consist of nickel on an activated carbon support. The catalyst can consist of nickel on a silicon carbide support.

The catalyst can comprise nickel on a metal oxide support. The catalyst can consist essentially of nickel on a metal oxide support. The catalyst can consist of nickel on a metal oxide support. The catalyst can comprise nickel on an alumina support. The catalyst can comprise nickel on a magnesium oxide support. The catalyst can comprise nickel on a titanium oxide support. The catalyst can comprise nickel on a zinc oxide support. The catalyst can comprise nickel on a zirconia support. The catalyst can comprise nickel on a chromia support. The catalyst can consist essentially of nickel on an alumina support. The catalyst can consist essentially of nickel on a magnesium oxide support. The catalyst can consist essentially of nickel on a titanium oxide support. The catalyst can consist essentially of nickel on a zinc oxide support. The catalyst can consist essentially of nickel on a zirconia support. The catalyst can consist essentially of nickel on a chromia support. The catalyst can consist of nickel on an alumina support. The catalyst can consist of nickel on a magnesium oxide support. The catalyst can consist of nickel on a titanium oxide support. The catalyst can consist of nickel on a zinc oxide support. The catalyst can consist of nickel on a zirconia support. The catalyst can consist of nickel on a chromia support.

The catalyst can comprise nickel oxide on a silica gel support. The catalyst can comprise nickel oxide on a zeolite support. The catalyst can comprise nickel oxide on an activated carbon support. The catalyst can comprise nickel oxide on a silicon carbide support. The catalyst can consist essentially of nickel oxide on a silica gel support. The catalyst can consist essentially of nickel oxide on a zeolite support. The catalyst can consist essentially of nickel oxide on an activated carbon support. The catalyst can consist essentially of nickel oxide on a silicon carbide support. The catalyst can consist of nickel oxide on a silica gel support. The catalyst can consist of nickel oxide on a zeolite support. The catalyst can consist of nickel oxide on an activated carbon support. The catalyst can consist of nickel oxide on a silicon carbide support.

The catalyst can comprise nickel oxide on a metal oxide support. The catalyst can consist essentially of nickel oxide on a metal oxide support. The catalyst can consist of nickel oxide on a metal oxide support. The catalyst can comprise nickel oxide on an alumina support. The catalyst can comprise nickel oxide on a magnesium oxide support. The catalyst can comprise nickel oxide on a titanium oxide support. The catalyst can comprise nickel oxide on a zinc oxide support. The catalyst can comprise nickel oxide on a zirconia support. The catalyst can comprise nickel oxide on a chromia support. The catalyst can consist essentially of nickel oxide on an alumina support. The catalyst can consist essentially of nickel oxide on a magnesium oxide support. The catalyst can consist essentially of nickel oxide on a titanium oxide support. The catalyst can consist essentially of nickel oxide on a zinc oxide support. The catalyst can consist essentially of nickel oxide on a zirconia support. The catalyst can consist essentially of nickel oxide on a chromia support. The catalyst can consist of nickel oxide on an alumina support. The catalyst can consist of nickel oxide on a magnesium oxide support. The catalyst can consist of nickel oxide on a titanium oxide support. The catalyst can consist of nickel oxide on a zinc oxide support. The catalyst can consist of nickel oxide on a zirconia support. The catalyst can consist of nickel oxide on a chromia support.

The catalyst can comprise nickel and nickel oxide on a silica gel support. The catalyst can comprise nickel and nickel oxide on a zeolite support. The catalyst can comprise nickel and nickel oxide on an activated carbon support. The catalyst can comprise nickel and nickel oxide on a silicon carbide support. The catalyst can consist essentially of nickel and nickel oxide on a silica gel support. The catalyst can consist essentially of nickel and nickel oxide on a zeolite support. The catalyst can consist essentially of nickel and nickel oxide on an activated carbon support. The catalyst can consist essentially of nickel and nickel oxide on a silicon carbide support. The catalyst can consist of nickel and nickel oxide on a silica gel support. The catalyst can consist of nickel and nickel oxide on a zeolite support. The catalyst can consist of nickel and nickel oxide on an activated carbon support. The catalyst can consist of nickel and nickel oxide on a silicon carbide support.

The catalyst can comprise nickel and nickel oxide on a metal oxide support. The catalyst can consist essentially of nickel and nickel oxide on a metal oxide support. The catalyst can consist of nickel and nickel oxide on a metal oxide support. The catalyst can comprise nickel and nickel oxide on an alumina support. The catalyst can comprise nickel and nickel oxide on a magnesium oxide support. The catalyst can comprise nickel and nickel oxide on a titanium oxide support. The catalyst can comprise nickel and nickel oxide on a zinc oxide support. The catalyst can comprise nickel and nickel oxide on a zirconia support. The catalyst can comprise nickel and nickel oxide on a chromia support. The catalyst can consist essentially of nickel and nickel oxide on an alumina support. The catalyst can consist essentially of nickel and nickel oxide on a magnesium oxide support. The catalyst can consist essentially of nickel and nickel oxide on a titanium oxide support. The catalyst can consist essentially of nickel and nickel oxide on a zinc oxide support. The catalyst can consist essentially of nickel and nickel oxide on a zirconia support. The catalyst can consist essentially of nickel and nickel oxide on a chromia support. The catalyst can consist of nickel and nickel oxide on an alumina support. The catalyst can consist of nickel and nickel oxide on a magnesium oxide support. The catalyst can consist of nickel and nickel oxide on a titanium oxide support. The catalyst can consist of nickel and nickel oxide on a zinc oxide support. The catalyst can consist of nickel and nickel oxide on a zirconia support. The catalyst can consist of nickel and nickel oxide on a chromia support.

The catalyst can comprise cobalt on a silica gel support. The catalyst can comprise cobalt on a zeolite support. The catalyst can comprise cobalt on an activated carbon support. The catalyst can comprise cobalt on a silicon carbide support. The catalyst can consist essentially of cobalt on a silica gel support. The catalyst can consist essentially of cobalt on a zeolite support. The catalyst can consist essentially of cobalt on an activated carbon support. The catalyst can consist essentially of cobalt on a silicon carbide support. The catalyst can consist of cobalt on a silica gel support. The catalyst can consist of cobalt on a zeolite support. The catalyst can consist of cobalt on an activated carbon support. The catalyst can consist of cobalt on a silicon carbide support.

The catalyst can comprise cobalt on a metal oxide support. The catalyst can consist essentially of cobalt on a metal oxide support. The catalyst can consist of cobalt on a metal oxide support. The catalyst can comprise cobalt on an alumina support. The catalyst can comprise cobalt on a magnesium oxide support. The catalyst can comprise cobalt on a titanium oxide support. The catalyst can comprise cobalt on a zinc oxide support. The catalyst can comprise cobalt on a zirconia support. The catalyst can comprise cobalt on a chromia support. The catalyst can consist essentially of cobalt on an alumina support. The catalyst can consist essentially of cobalt on a magnesium oxide support. The catalyst can consist essentially of cobalt on a titanium oxide support. The catalyst can consist essentially of cobalt on a zinc oxide support. The catalyst can consist essentially of cobalt on a zirconia support. The catalyst can consist essentially of cobalt on a chromia support. The catalyst can consist of cobalt on an alumina support. The catalyst can consist of cobalt on a magnesium oxide support. The catalyst can consist of cobalt on a titanium oxide support. The catalyst can consist of cobalt on a zinc oxide support. The catalyst can consist of cobalt on a zirconia support. The catalyst can consist of cobalt on a chromia support.

The catalyst can comprise cobalt oxide on a silica gel support. The catalyst can comprise cobalt oxide on a zeolite support. The catalyst can comprise cobalt oxide on an activated carbon support. The catalyst can comprise cobalt oxide on a silicon carbide support. The catalyst can consist essentially of cobalt oxide on a silica gel support. The catalyst can consist essentially of cobalt oxide on a zeolite support. The catalyst can consist essentially of cobalt oxide on an activated carbon support. The catalyst can consist essentially of cobalt oxide on a silicon carbide support. The catalyst can consist of cobalt oxide on a silica gel support. The catalyst can consist of cobalt oxide on a zeolite support. The catalyst can consist of cobalt oxide on an activated carbon support. The catalyst can consist of cobalt oxide on a silicon carbide support.

The catalyst can comprise cobalt oxide on a metal oxide support. The catalyst can consist essentially of cobalt oxide on a metal oxide support. The catalyst can consist of cobalt oxide on a metal oxide support. The catalyst can comprise cobalt oxide on an alumina support. The catalyst can comprise cobalt oxide on a magnesium oxide support. The catalyst can comprise cobalt oxide on a titanium oxide support. The catalyst can comprise cobalt oxide on a zinc oxide support. The catalyst can comprise cobalt oxide on a zirconia support. The catalyst can comprise cobalt oxide on a chromia support. The catalyst can consist essentially of cobalt oxide on an alumina support. The catalyst can consist essentially of cobalt oxide on a magnesium oxide support. The catalyst can consist essentially of cobalt oxide on a titanium oxide support. The catalyst can consist essentially of cobalt oxide on a zinc oxide support. The catalyst can consist essentially of cobalt oxide on a zirconia support. The catalyst can consist essentially of cobalt oxide on a chromia support. The catalyst can consist of cobalt oxide on an alumina support. The catalyst can consist of cobalt oxide on a magnesium oxide support. The catalyst can consist of cobalt oxide on a titanium oxide support. The catalyst can consist of cobalt oxide on a zinc oxide support. The catalyst can consist of cobalt oxide on a zirconia support. The catalyst can consist of cobalt oxide on a chromia support.

The catalyst can comprise cobalt and cobalt oxide on a silica gel support. The catalyst can comprise cobalt and cobalt oxide on a zeolite support. The catalyst can comprise cobalt and cobalt oxide on an activated carbon support. The catalyst can comprise cobalt and cobalt oxide on a silicon carbide support. The catalyst can consist essentially of cobalt and cobalt oxide on a silica gel support. The catalyst can consist essentially of cobalt and cobalt oxide on a zeolite support. The catalyst can consist essentially of cobalt and cobalt oxide on an activated carbon support. The catalyst can consist essentially of cobalt and cobalt oxide on a silicon carbide support. The catalyst can consist of cobalt and cobalt oxide on a silica gel support. The catalyst can consist of cobalt and cobalt oxide on a zeolite support. The catalyst can consist of cobalt and cobalt oxide on an activated carbon support. The catalyst can consist of cobalt and cobalt oxide on a silicon carbide support.

The catalyst can comprise cobalt and cobalt oxide on a metal oxide support. The catalyst can consist essentially of cobalt and cobalt oxide on a metal oxide support. The catalyst can consist of cobalt and cobalt oxide on a metal oxide support. The catalyst can comprise cobalt and cobalt oxide on an alumina support. The catalyst can comprise cobalt and cobalt oxide on a magnesium oxide support. The catalyst can comprise cobalt and cobalt oxide on a titanium oxide support. The catalyst can comprise cobalt and cobalt oxide on a zinc oxide support. The catalyst can comprise cobalt and cobalt oxide on a zirconia support. The catalyst can comprise cobalt and cobalt oxide on a chromia support. The catalyst can consist essentially of cobalt and cobalt oxide on an alumina support. The catalyst can consist essentially of cobalt and cobalt oxide on a magnesium oxide support. The catalyst can consist essentially of cobalt and cobalt oxide on a titanium oxide support. The catalyst can consist essentially of cobalt and cobalt oxide on a zinc oxide support. The catalyst can consist essentially of cobalt and cobalt oxide on a zirconia support. The catalyst can consist essentially of cobalt and cobalt oxide on a chromia support. The catalyst can consist of cobalt and cobalt oxide on an alumina support. The catalyst can consist of cobalt and cobalt oxide on a magnesium oxide support. The catalyst can consist of cobalt and cobalt oxide on a titanium oxide support. The catalyst can consist of cobalt and cobalt oxide on a zinc oxide support. The catalyst can consist of cobalt and cobalt oxide on a zirconia support. The catalyst can consist of cobalt and cobalt oxide on a chromia support.

The catalyst can comprise iron on a silica gel support. The catalyst can comprise iron on a zeolite support. The catalyst can comprise iron on an activated carbon support. The catalyst can comprise iron on a silicon carbide support. The catalyst can consist essentially of iron on a silica gel support. The catalyst can consist essentially of iron on a zeolite support. The catalyst can consist essentially of iron on an activated carbon support. The catalyst can consist essentially of iron on a silicon carbide support. The catalyst can consist of iron on a silica gel support. The catalyst can consist of iron on a zeolite support. The catalyst can consist of iron on an activated carbon support. The catalyst can consist of iron on a silicon carbide support.

The catalyst can comprise iron on a metal oxide support. The catalyst can consist essentially of iron on a metal oxide support. The catalyst can consist of iron on a metal oxide support. The catalyst can comprise iron on an alumina support. The catalyst can comprise iron on a magnesium oxide support. The catalyst can comprise iron on a titanium oxide support. The catalyst can comprise iron on a zinc oxide support. The catalyst can comprise iron on a zirconia support. The catalyst can comprise iron on a chromia support. The catalyst can consist essentially of iron on an alumina support. The catalyst can consist essentially of iron on a magnesium oxide support. The catalyst can consist essentially of iron on a titanium oxide support. The catalyst can consist essentially of iron on a zinc oxide support. The catalyst can consist essentially of iron on a zirconia support. The catalyst can consist essentially of iron on a chromia support. The catalyst can consist of iron on an alumina support. The catalyst can consist of iron on a magnesium oxide support. The catalyst can consist of iron on a titanium oxide support. The catalyst can consist of iron on a zinc oxide support. The catalyst can consist of iron on a zirconia support. The catalyst can consist of iron on a chromia support.

The catalyst can comprise iron oxide on a silica gel support. The catalyst can comprise iron oxide on a zeolite support. The catalyst can comprise iron oxide on an activated carbon support. The catalyst can comprise iron oxide on a silicon carbide support. The catalyst can consist essentially of iron oxide on a silica gel support. The catalyst can consist essentially of iron oxide on a zeolite support. The catalyst can consist essentially of iron oxide on an activated carbon support. The catalyst can consist essentially of iron oxide on a silicon carbide support. The catalyst can consist of iron oxide on a silica gel support. The catalyst can consist of iron oxide on a zeolite support. The catalyst can consist of iron oxide on an activated carbon support. The catalyst can consist of iron oxide on a silicon carbide support.

The catalyst can comprise iron oxide on a metal oxide support. The catalyst can consist essentially of iron oxide on a metal oxide support. The catalyst can consist of iron oxide on a metal oxide support. The catalyst can comprise iron oxide on an alumina support. The catalyst can comprise iron oxide on a magnesium oxide support. The catalyst can comprise iron oxide on a titanium oxide support. The catalyst can comprise iron oxide on a zinc oxide support. The catalyst can comprise iron oxide on a zirconia support. The catalyst can comprise iron oxide on a chromia support. The catalyst can consist essentially of iron oxide on an alumina support. The catalyst can consist essentially of iron oxide on a magnesium oxide support. The catalyst can consist essentially of iron oxide on a titanium oxide support. The catalyst can consist essentially of iron oxide on a zinc oxide support. The catalyst can consist essentially of iron oxide on a zirconia support. The catalyst can consist essentially of iron oxide on a chromia support. The catalyst can consist of iron oxide on an alumina support. The catalyst can consist of iron oxide on a magnesium oxide support. The catalyst can consist of iron oxide on a titanium oxide support. The catalyst can consist of iron oxide on a zinc oxide support. The catalyst can consist of iron oxide on a zirconia support. The catalyst can consist of iron oxide on a chromia support.

The catalyst can comprise iron and iron oxide on a silica gel support. The catalyst can comprise iron and iron oxide on a zeolite support. The catalyst can comprise iron and iron oxide on an activated carbon support. The catalyst can comprise iron and iron oxide on a silicon carbide support. The catalyst can consist essentially of iron and iron oxide on a silica gel support. The catalyst can consist essentially of iron and iron oxide on a zeolite support. The catalyst can consist essentially of iron and iron oxide on an activated carbon support. The catalyst can consist essentially of iron and iron oxide on a silicon carbide support. The catalyst can consist of iron and iron oxide on a silica gel support. The catalyst can consist of iron and iron oxide on a zeolite support. The catalyst can consist of iron and iron oxide on an activated carbon support. The catalyst can consist of iron and iron oxide on a silicon carbide support.

The catalyst can comprise iron and iron oxide on a metal oxide support. The catalyst can consist essentially of iron and iron oxide on a metal oxide support. The catalyst can consist of iron and iron oxide on a metal oxide support. The catalyst can comprise iron and iron oxide on an alumina support. The catalyst can comprise iron and iron oxide on a magnesium oxide support. The catalyst can comprise iron and iron oxide on a titanium oxide support. The catalyst can comprise iron and iron oxide on a zinc oxide support. The catalyst can comprise iron and iron oxide on a zirconia support. The catalyst can comprise iron and iron oxide on a chromia support. The catalyst can consist essentially of iron and iron oxide on an alumina support. The catalyst can consist essentially of iron and iron oxide on a magnesium oxide support. The catalyst can consist essentially of iron and iron oxide on a titanium oxide support. The catalyst can consist essentially of iron and iron oxide on a zinc oxide support. The catalyst can consist essentially of iron and iron oxide on a zirconia support. The catalyst can consist essentially of iron and iron oxide on a chromia support. The catalyst can consist of iron and iron oxide on an alumina support. The catalyst can consist of iron and iron oxide on a magnesium oxide support. The catalyst can consist of iron and iron oxide on a titanium oxide support. The catalyst can consist of iron and iron oxide on a zinc oxide support. The catalyst can consist of iron and iron oxide on a zirconia support. The catalyst can consist of iron and iron oxide on a chromia support.

The catalyst can comprise nickel and cobalt on a silica gel support. The catalyst can comprise nickel and cobalt on a zeolite support. The catalyst can comprise nickel and cobalt on an activated carbon support. The catalyst can comprise nickel and cobalt on a silicon carbide support. The catalyst can consist essentially of nickel and cobalt on a silica gel support. The catalyst can consist essentially of nickel and cobalt on a zeolite support. The catalyst can consist essentially of nickel and cobalt on an activated carbon support. The catalyst can consist essentially of nickel and cobalt on a silicon carbide support. The catalyst can consist of nickel and cobalt on a silica gel support. The catalyst can consist of nickel and cobalt on a zeolite support. The catalyst can consist of nickel and cobalt on an activated carbon support. The catalyst can consist of nickel and cobalt on a silicon carbide support.

The catalyst can comprise nickel and cobalt on a metal oxide support. The catalyst can consist essentially of nickel and cobalt on a metal oxide support. The catalyst can consist of nickel and cobalt on a metal oxide support. The catalyst can comprise nickel and cobalt on an alumina support. The catalyst can comprise nickel and cobalt on a magnesium oxide support. The catalyst can comprise nickel and cobalt on a titanium oxide support. The catalyst can comprise nickel and cobalt on a zinc oxide support. The catalyst can comprise nickel and cobalt on a zirconia support. The catalyst can comprise nickel and cobalt on a chromia support. The catalyst can consist essentially of nickel and cobalt on an alumina support. The catalyst can consist essentially of nickel and cobalt on a magnesium oxide support. The catalyst can consist essentially of nickel and cobalt on a titanium oxide support. The catalyst can consist essentially of nickel and cobalt on a zinc oxide support. The catalyst can consist essentially of nickel and cobalt on a zirconia support. The catalyst can consist essentially of nickel and cobalt on a chromia support. The catalyst can consist of nickel and cobalt on an alumina support. The catalyst can consist of nickel and cobalt on a magnesium oxide support. The catalyst can consist of nickel and cobalt on a titanium oxide support. The catalyst can consist of nickel and cobalt on a zinc oxide support. The catalyst can consist of nickel and cobalt on a zirconia support. The catalyst can consist of nickel and cobalt on a chromia support.

The catalyst can comprise nickel oxide and cobalt oxide on a silica gel support. The catalyst can comprise nickel oxide and cobalt oxide on a zeolite support. The catalyst can comprise nickel oxide and cobalt oxide on an activated carbon support. The catalyst can comprise nickel oxide and cobalt oxide on a silicon carbide support. The catalyst can consist essentially of nickel oxide and cobalt oxide on a silica gel support. The catalyst can consist essentially of nickel oxide and cobalt oxide on a zeolite support. The catalyst can consist essentially of nickel oxide and cobalt oxide on an activated carbon support. The catalyst can consist essentially of nickel oxide and cobalt oxide on a silicon carbide support. The catalyst can consist of nickel oxide and cobalt oxide on a silica gel support. The catalyst can consist of nickel oxide and cobalt oxide on a zeolite support. The catalyst can consist of nickel oxide and cobalt oxide on an activated carbon support. The catalyst can consist of nickel oxide and cobalt oxide on a silicon carbide support.

The catalyst can comprise nickel oxide and cobalt oxide on a metal oxide support. The catalyst can consist essentially of nickel oxide and cobalt oxide on a metal oxide support. The catalyst can consist of nickel oxide and cobalt oxide on a metal oxide support. The catalyst can comprise nickel oxide and cobalt oxide on an alumina support. The catalyst can comprise nickel oxide and cobalt oxide on a magnesium oxide support. The catalyst can comprise nickel oxide and cobalt oxide on a titanium oxide support. The catalyst can comprise nickel oxide and cobalt oxide on a zinc oxide support. The catalyst can comprise nickel oxide and cobalt oxide on a zirconia support. The catalyst can comprise nickel oxide and cobalt oxide on a chromia support. The catalyst can consist essentially of nickel oxide and cobalt oxide on an alumina support. The catalyst can consist essentially of nickel oxide and cobalt oxide on a magnesium oxide support. The catalyst can consist essentially of nickel oxide and cobalt oxide on a titanium oxide support. The catalyst can consist essentially of nickel oxide and cobalt oxide on a zinc oxide support. The catalyst can consist essentially of nickel oxide and cobalt oxide on a zirconia support. The catalyst can consist essentially of nickel oxide and cobalt oxide on a chromia support. The catalyst can consist of nickel oxide and cobalt oxide on an alumina support. The catalyst can consist of nickel oxide and cobalt oxide on a magnesium oxide support. The catalyst can consist of nickel oxide and cobalt oxide on a titanium oxide support. The catalyst can consist of nickel oxide and cobalt oxide on a zinc oxide support. The catalyst can consist of nickel oxide and cobalt oxide on a zirconia support. The catalyst can consist of nickel oxide and cobalt oxide on a chromia support.

The catalyst can comprise nickel and iron on a silica gel support. The catalyst can comprise nickel and iron on a zeolite support. The catalyst can comprise nickel and iron on an activated carbon support. The catalyst can comprise nickel and iron on a silicon carbide support. The catalyst can consist essentially of nickel and iron on a silica gel support. The catalyst can consist essentially of nickel and iron on a zeolite support. The catalyst can consist essentially of nickel and iron on an activated carbon support. The catalyst can consist essentially of nickel and iron on a silicon carbide support. The catalyst can consist of nickel and iron on a silica gel support. The catalyst can consist of nickel and iron on a zeolite support. The catalyst can consist of nickel and iron on an activated carbon support. The catalyst can consist of nickel and iron on a silicon carbide support.

The catalyst can comprise nickel and iron on a metal oxide support. The catalyst can consist essentially of nickel and iron on a metal oxide support. The catalyst can consist of nickel and iron on a metal oxide support. The catalyst can comprise nickel and iron on an alumina support. The catalyst can comprise nickel and iron on a magnesium oxide support. The catalyst can comprise nickel and iron on a titanium oxide support. The catalyst can comprise nickel and iron on a zinc oxide support. The catalyst can comprise nickel and iron on a zirconia support. The catalyst can comprise nickel and iron on a chromia support. The catalyst can consist essentially of nickel and iron on an alumina support. The catalyst can consist essentially of nickel and iron on a magnesium oxide support. The catalyst can consist essentially of nickel and iron on a titanium oxide support. The catalyst can consist essentially of nickel and iron on a zinc oxide support. The catalyst can consist essentially of nickel and iron on a zirconia support. The catalyst can consist essentially of nickel and iron on a chromia support. The catalyst can consist of nickel and iron on an alumina support. The catalyst can consist of nickel and iron on a magnesium oxide support. The catalyst can consist of nickel and iron on a titanium oxide support. The catalyst can consist of nickel and iron on a zinc oxide support. The catalyst can consist of nickel and iron on a zirconia support. The catalyst can consist of nickel and iron on a chromia support.

The catalyst can comprise nickel oxide and iron oxide on a silica gel support. The catalyst can comprise nickel oxide and iron oxide on a zeolite support. The catalyst can comprise nickel oxide and iron oxide on an activated carbon support. The catalyst can comprise nickel oxide and iron oxide on a silicon carbide support. The catalyst can consist essentially of nickel oxide and iron oxide on a silica gel support. The catalyst can consist essentially of nickel oxide and iron oxide on a zeolite support. The catalyst can consist essentially of nickel oxide and iron oxide on an activated carbon support. The catalyst can consist essentially of nickel oxide and iron oxide on a silicon carbide support. The catalyst can consist of nickel oxide and iron oxide on a silica gel support. The catalyst can consist of nickel oxide and iron oxide on a zeolite support. The catalyst can consist of nickel oxide and iron oxide on an activated carbon support. The catalyst can consist of nickel oxide and iron oxide on a silicon carbide support.

The catalyst can comprise nickel oxide and iron oxide on a metal oxide support. The catalyst can consist essentially of nickel oxide and iron oxide on a metal oxide support. The catalyst can consist of nickel oxide and iron oxide on a metal oxide support. The catalyst can comprise nickel oxide and iron oxide on an alumina support. The catalyst can comprise nickel oxide and iron oxide on a magnesium oxide support. The catalyst can comprise nickel oxide and iron oxide on a titanium oxide support. The catalyst can comprise nickel oxide and iron oxide on a zinc oxide support. The catalyst can comprise nickel oxide and iron oxide on a zirconia support. The catalyst can comprise nickel oxide and iron oxide on a chromia support. The catalyst can consist essentially of nickel oxide and iron oxide on an alumina support. The catalyst can consist essentially of nickel oxide and iron oxide on a magnesium oxide support. The catalyst can consist essentially of nickel oxide and iron oxide on a titanium oxide support. The catalyst can consist essentially of nickel oxide and iron oxide on a zinc oxide support. The catalyst can consist essentially of nickel oxide and iron oxide on a zirconia support. The catalyst can consist essentially of nickel oxide and iron oxide on a chromia support. The catalyst can consist of nickel oxide and iron oxide on an alumina support. The catalyst can consist of nickel oxide and iron oxide on a magnesium oxide support. The catalyst can consist of nickel oxide and iron oxide on a titanium oxide support. The catalyst can consist of nickel oxide and iron oxide on a zinc oxide support. The catalyst can consist of nickel oxide and iron oxide on a zirconia support. The catalyst can consist of nickel oxide and iron oxide on a chromia support.

The catalyst can comprise cobalt and iron on a silica gel support. The catalyst can comprise cobalt and iron on a zeolite support. The catalyst can comprise cobalt and iron on an activated carbon support. The catalyst can comprise cobalt and iron on a silicon carbide support. The catalyst can consist essentially of cobalt and iron on a silica gel support. The catalyst can consist essentially of cobalt and iron on a zeolite support. The catalyst can consist essentially of cobalt and iron on an activated carbon support. The catalyst can consist essentially of cobalt and iron on a silicon carbide support. The catalyst can consist of cobalt and iron on a silica gel support. The catalyst can consist of cobalt and iron on a zeolite support. The catalyst can consist of cobalt and iron on an activated carbon support. The catalyst can consist of cobalt and iron on a silicon carbide support.

The catalyst can comprise cobalt and iron on a metal oxide support. The catalyst can consist essentially of cobalt and iron on a metal oxide support. The catalyst can consist of cobalt and iron on a metal oxide support. The catalyst can comprise cobalt and iron on an alumina support. The catalyst can comprise cobalt and iron on a magnesium oxide support. The catalyst can comprise cobalt and iron on a titanium oxide support. The catalyst can comprise cobalt and iron on a zinc oxide support. The catalyst can comprise cobalt and iron on a zirconia support. The catalyst can comprise cobalt and iron on a chromia support. The catalyst can consist essentially of cobalt and iron on an alumina support. The catalyst can consist essentially of cobalt and iron on a magnesium oxide support. The catalyst can consist essentially of cobalt and iron on a titanium oxide support. The catalyst can consist essentially of cobalt and iron on a zinc oxide support. The catalyst can consist essentially of cobalt and iron on a zirconia support. The catalyst can consist essentially of cobalt and iron on a chromia support. The catalyst can consist of cobalt and iron on an alumina support. The catalyst can consist of cobalt and iron on a magnesium oxide support. The catalyst can consist of cobalt and iron on a titanium oxide support. The catalyst can consist of cobalt and iron on a zinc oxide support. The catalyst can consist of cobalt and iron on a zirconia support. The catalyst can consist of cobalt and iron on a chromia support.

The catalyst can comprise cobalt oxide and iron oxide on a silica gel support. The catalyst can comprise cobalt oxide and iron oxide on a zeolite support. The catalyst can comprise cobalt oxide and iron oxide on an activated carbon support. The catalyst can comprise cobalt oxide and iron oxide on a silicon carbide support. The catalyst can consist essentially of cobalt oxide and iron oxide on a silica gel support. The catalyst can consist essentially of cobalt oxide and iron oxide on a zeolite support. The catalyst can consist essentially of cobalt oxide and iron oxide on an activated carbon support. The catalyst can consist essentially of cobalt oxide and iron oxide on a silicon carbide support. The catalyst can consist of cobalt oxide and iron oxide on a silica gel support. The catalyst can consist of cobalt oxide and iron oxide on a zeolite support. The catalyst can consist of cobalt oxide and iron oxide on an activated carbon support. The catalyst can consist of cobalt oxide and iron oxide on a silicon carbide support.

The catalyst can comprise cobalt oxide and iron oxide on a metal oxide support. The catalyst can consist essentially of cobalt oxide and iron oxide on a metal oxide support. The catalyst can consist of cobalt oxide and iron oxide on a metal oxide support. The catalyst can comprise cobalt oxide and iron oxide on an alumina support. The catalyst can comprise cobalt oxide and iron oxide on a magnesium oxide support. The catalyst can comprise cobalt oxide and iron oxide on a titanium oxide support. The catalyst can comprise cobalt oxide and iron oxide on a zinc oxide support. The catalyst can comprise cobalt oxide and iron oxide on a zirconia support. The catalyst can comprise cobalt oxide and iron oxide on a chromia support. The catalyst can consist essentially of cobalt oxide and iron oxide on an alumina support. The catalyst can consist essentially of cobalt oxide and iron oxide on a magnesium oxide support. The catalyst can consist essentially of cobalt oxide and iron oxide on a titanium oxide support. The catalyst can consist essentially of cobalt oxide and iron oxide on a zinc oxide support. The catalyst can consist essentially of cobalt oxide and iron oxide on a zirconia support. The catalyst can consist essentially of cobalt oxide and iron oxide on a chromia support. The catalyst can consist of cobalt oxide and iron oxide on an alumina support. The catalyst can consist of cobalt oxide and iron oxide on a magnesium oxide support. The catalyst can consist of cobalt oxide and iron oxide on a titanium oxide support. The catalyst can consist of cobalt oxide and iron oxide on a zinc oxide support. The catalyst can consist of cobalt oxide and iron oxide on a zirconia support. The catalyst can consist of cobalt oxide and iron oxide on a chromia support.

The weight percentage of the catalyst, as a percentage of the total weight of the catalyst and the support, may be as little as about 0.03 weight percent (wt. %), about 0.05 wt. %, about 1 wt. %, about 5 wt. %, about 10 wt. %, about 15%, or about 20 wt. %, or as high as about 35 wt. %, about 40 wt. %, about 45 wt. %, or about 50 wt. %, or within any range defined between any two of the foregoing values, such as about 0.03 wt. % to about 50 wt. %, about 0.5 wt. % to about 45 wt. %, about 10 wt. % to about 40 wt. %, about 15 wt. % to about 35 wt. %, or about 3 wt. % to about 25 wt. %, for example. Preferably, weight percentage of the catalyst is from about 0.03 wt. % to about 5 wt. %. More preferably, the weight percentage of the catalyst is from about 0.03 wt. % to about 2 wt. %. Most preferably, the weight percentage of the catalyst is from about 0.05 wt. % to about 1 wt. %.

The catalyst may have a surface area as small as about 1 square meters per gram (m²/g), about 5 m²/g, about 10 m²/g, about 25 m²/g, about 40 m²/g, about 60 m²/g, or about 80 m²/g, or as large as about 100 m²/g, about 120 m²/g, about 150 m²/g, about 200 m²/g, about 250 m²/g, about 300 m²/g, or about 1,000 m²/g, or within any range defined between any two of the foregoing values, such as about 1 m²/g to about 1.00 m²/g, about 5 m²/g to about 300 m²/g, about 10 m²/g to about 250 m²/g, about 25 m²/g to about 200 m²/g, about 40 m²/g to about 150 m²/g, about 60 m²/g to about 120 m²/g, or about 80 m²/g to about 120 m²/g, for example. The surface area of the catalyst is determined by the BET method per ISO 9277:2010.

The reactant stream may be in contact with the catalyst for a contact time as short as about 0.1 second, about 2 seconds, about 4 seconds, about 6 seconds, about 8 seconds, about 10 seconds, about 15 seconds, about 20 seconds, about 25 seconds, or about 30 seconds, or as long as about 40 seconds, about 50 seconds, about 60 seconds, about 70 seconds, about 80 seconds, about 100 seconds, about 120 seconds, or about 1,800 seconds or within any range defined between any two of the foregoing values, such as about 0.1 seconds to about 1,800 seconds, about 2 seconds to about 120 seconds, about 4 second to about 100 seconds, about 6 seconds to about 80 seconds, about 8 seconds to about 70 seconds, about 10 seconds to about 60 seconds, about 15 seconds to about 50 seconds, about 20 seconds to about 40 seconds, about 20 seconds to about 30 seconds, about 10 seconds to about 20 seconds, or about 100 seconds to about 120 seconds, for example. Preferably, the reactant stream is in contact with the catalyst for a contact time from about 2 second to about 100 seconds. More preferably, the reactant stream is in contact with the catalyst for a contact time from about 2 seconds to about 60 seconds. Most preferably, the reactant stream is in contact with the catalyst for a contact time from about 2 seconds to about 40 seconds.

Prior to the reaction, the hydrogen (H₂) and the iodine (I₂) dissolved in a solvent are fed to a preheater. The preheater may be heated to a reaction temperature as low as about 170° C., about 180°, about 185° C., about 190° C., or as high as about 195° C., about 200° C., about 210° C., or about 220° C., or within any range defined between any two of the foregoing values, such as about 170° C. to about 220° C., about 170° C. to about 200° C., about 180° C. to about 195° C., about 170° C. to about 180° C., or about 200° C. to about 210° C. Preferably, the temperature is about 170° C. to about 210° C. More preferably, the temperature is 180° C. to about 200° C.

The mixture is then passed to a furnace containing a heated catalyst. The catalyst may be heated to a reaction temperature as low as about 300° C., about 200° C., about 250° C., about 280° C., about 290° C., about 300° C., about 310° C., or about 320° C., or to a reaction temperature as high as about 330° C., about 340° C., about 350° C., about 360° C., about 380° C., about 400° C., about 450° C., about 500° C., about 550° C., or about 600° C., or within any range defined between any two of the foregoing values, such as about 150° C. to about 600° C., about 200° C. to about 550° C., about 250° C. to about 500° C., about 280° C. to about 450° C., about 290° C. to about 400° C., about 300° C. to about 380° C., about 310° C. to about 360° C., about 320° C. to about 350° C., or about 320° C. to about 340° C., for example. Preferably, the reaction temperature is from about 200° C. to about 550° C. More preferably, the reaction temperature is from about 300° C. to about 500° C. Most preferably, the reaction temperature is from about 350° C. to about 450° C.

The hydrogen in the flow of reactants to the reactor will reduce a catalyst including nickel oxide, cobalt oxide, and iron oxide to the corresponding metal. Optionally, such catalysts may also be reduced by a flow of hydrogen through the reactor prior to the reaction.

Pressure is not critical, though the pressure may be sufficiently high to keep the solvent in liquid form. Convenient operating pressures range from about 10 kPa to about 4,000 kPa, and preferably from about 30 kPa to about 300 kPa.

The product stream including hydrogen iodide (HI), unreacted hydrogen (H₂), and unreacted iodine (I₂) dissolved in a solvent is directed from the reactor to at least two cold traps, the first at a higher temperature than the second, in which the product stream is cooled to allow collection of at least some of the unreacted iodine (I₂) dissolved in the solvent as well as the product HI. Unreacted hydrogen (H₂) may also be collected. Unreacted iodine (I₂) dissolved in the solvent is collected in the first trap. The crude HI is collected in the second trap. Most of the HI is collected in the second trap, though a minor amount may remain dissolved in the solvent in the first trap. The unreacted hydrogen (H₂), unreacted iodine (I₂) dissolved in the solvent, and any minor amounts of HI product may be recycled back to the reactor.

The temperature of the first cold trap may be as low as about −30° C., about −25° C., about −20° C., or as high as about −15° C., about −10° C. about −5° C., or about 0° C., or within any range defined between any two of the foregoing values, such as about −30° C. to about 0° C., about −20° C. to about −10° C., about −25° C. to about −20° C., or about −15° C. to about −10° C. Preferably, the temperature is about −30° C. to about −10° C. More preferably, the temperature is about −25° C. to about −15° C. Most preferably, the temperature is −20° C.

The temperature of the second cold trap may be as low as about −225° C., about −200° C., about −196° C., or as high as about −195° C., about −190° C. or about −180° C., or within any range defined between any two of the foregoing values, such as about −225° C. to about −180° C., about −196° C. to about −190° C., about −200° C. to about −196° C., or about −195° C. to about −180° C. Preferably, the temperature is about −225° C. to about −190° C. More preferably, the temperature is about −200° C. to about −195° C. Most preferably, the temperature is −196° C.

The processes for the manufacture of hydrogen iodide (HI) from hydrogen (H₂) and elemental iodine (I₂) dissolved in a solvent selected from at least one of ethers, such as diethyl ether and diglyme; nitriles, such as benzonitrile and acetonitrile; and formamides, such as dimethylformamide; ionic liquids, such as 1-ethyl-3-methylimidazolium acetate; sulfolane; carbon disulfide; toluene; naphthalene; xylene; 2,2-dimethylbutane; cyclohexane; ethanol; perfluoroheptane; and mesitylene, that include the use of a platinum, palladium, nickel, cobalt, iron, nickel oxide, cobalt oxide, and iron oxide catalyst, wherein the catalyst is supported on a support, according to this disclosure may be batch processes or may be continuous processes, as described below.

The FIGURE is a process flow diagram showing a process for manufacturing hydrogen iodide (HI). As shown in the FIGURE, the process includes material flows of iodine (I₂) dissolved in a solvent 10 and hydrogen gas 12. The flow rate of hydrogen gas 12 may be controlled by a flow controller (not shown). The mixture may be fed to a preheater 14, maintained above the melting point of iodine (I₂). The heated mixture 16 may be fed to a reactor 18, such as a tubular reactor furnace. In the reactor, the mixture contacted with the catalyst 20, such as by directing the mixture through a heated catalyst column supplied with an inert gas, such as nitrogen.

The product stream 22 may include hydrogen iodide (HI), unreacted iodine (I₂) dissolved in the solvent, unreacted hydrogen (H₂), and trace amounts of water. The product stream 22 may be directed to a first cold trap 24 where the product stream 22 may be cooled to permit collection of unreacted iodine (I₂) dissolved in the solvent 32. The unreacted iodine dissolved in the solvent 32 may be recycled back to the dissolved iodine (I₂) feed stream 10.

The product stream 26 may include unreacted hydrogen (H₂), hydrogen iodide (HI), and trace amounts of water. The product stream 26 may then be directed to a second cold trap 28, maintained at a temperature lower than the temperature of the first cold trap, where the product stream may be cooled to permit collection of hydrogen iodide (HI). Unreacted hydrogen (H₂) 30 may be recycled back to the hydrogen (H₂) gas feed stream 12. The product hydrogen iodide (HI) 34 is collected in the exit stream.

While this disclosure has been described as relative to exemplary designs, the present disclosure may be further modified within the spirit and scope of this disclosure. Further, this application is intended to cover such departures from the present disclosure as come within known or customary practice in the art to which this disclosure pertains.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

### EXAMPLES

### Example 1: Reaction of Hydrogen with Iodine Dissolved in Mesitylene

A Monel tube reactor (0.5″×15″) packed with 1% platinum on alumina pellets (catalyst volume: about 26 cm³, 13″×0.5″ heated zone) equipped with a preheater (190° C.-200° C.) was heated to and maintained at 415° C.-420° C. for about 1 hour. After this, hydrogen (67 standard cm³/minute (sccm) or about 0.34 g/hour) and an 18 wt. % solution of iodine in mesitylene (0.5 mL/min, about 5.14 g iodine/hour) were introduced to the preheater/reactor via flow meter and syringe pump, respectively. The ratio of hydrogen (H₂) to iodine (I₂) was about 9:1. The product stream containing hydrogen iodide (HI), unreacted iodine (I₂), mesitylene solvent, and unreacted hydrogen (H₂) was passed through two cold traps at −20° C. and −196° C., respectively. Under these conditions, 7.1 g hydrogen iodide (HI) (39% yield, based on iodine) and 90 g of mesitylene and unreacted iodine were collected in the −196° C. and −20° C. cold traps, respectively, over the 3.5 hour run time. Gas chromatography (GC) analysis of the 90 g sample showed mesitylene as the only organic compound. Change in mass balance for the reaction was within 3%. No significant decomposition of mesitylene was seen under these conditions.

### Example 2: Reaction of Hydrogen and with Iodine Dissolved in p-Xylene

The reaction was carried in a similar manner as described in Example 1, using 0.5% palladium on alumina catalyst and iodine (I₂), 15 wt. % dissolved in p-xylene. The hydrogen (H₂) flow rate was 150 sccm, or about 0.76 g/hr, and the 15 wt. % solution of iodine (I₂) in p-xylene is delivered at a rate of 0.5 mL/min, about 4.5 g/hour. Under these conditions, 1.9 g of hydrogen iodine (HI) was collected in the second cold trap to give a conversion of 28% over the 1.5 hour run time. The temperatures of the first and second cold traps were −20° C. and −196° C., respectively. Gas chromatography-mass spectrometry (GC-MS) analysis of the liquid collected in 0° C. trap mainly showed p-xylene.

### Example 3: Reaction of Hydrogen with Iodine Dissolved in an Ionic Liquid

The experiment was conducted as described in Example 1, using a 20 wt. % solution of iodine dissolved in the ionic liquid, 1-ethyl-3-methylimidazolium acetate, instead of iodine in mesitylene. Under these conditions no hydrogen iodide (HI) was obtained, but GC-MS of the gaseous materials in the −196° C. trap indicated the presence of CH₃I, C₂H₅I, C₃H₇I, in decreasing amounts.

### ASPECTS

Aspect 1 is a process for producing hydrogen iodide. The process includes providing a reactant stream comprising hydrogen and iodine, the iodine dissolved in a solvent, and reacting the reactant stream in the presence of a catalyst to produce a product stream comprising hydrogen iodide.

Aspect 2 is the process of aspect 1, wherein in the providing step, the solvent comprises at least one selected from the group of diethyl ether, diglyme, benzonitrile, acetonitrile, dimethylformamide, 1-ethyl-3-methylimidazolium acetate, sulfolane, carbon disulfide, acetone, toluene, naphthalene, xylene, 2,2-dimethylbutane, cyclohexane, ethanol, perfluoroheptane, and mesitylene.

Aspect 3 is the process of aspect 1, wherein in the providing step, the catalyst comprises at least one of the group of platinum, palladium, nickel, cobalt, iron, nickel oxide, cobalt oxide, and iron oxide, and wherein the catalyst is supported on a support.

Aspect 4 is the process of any of aspects 1, 2 or 3, wherein the support is selected from the group of activated carbon, silica gel, zeolite, silicon carbide, metal oxides, or combinations thereof.

Aspect 5 is the process of any of aspects 1-4, wherein the support is a metal oxide support, the metal oxide support including alumina, magnesium oxide, titanium oxide, zinc oxide, zirconia, chromia, and combinations thereof.

Aspect 6 is the process of aspect 5, wherein the catalyst is selected from platinum on an alumina support or palladium on an alumina support.

Aspect 7 is the process of aspect 1, wherein catalyst is from about 0.03 wt. % to about 50 wt. % of the total weight of the catalyst and the support.

Aspect 8 is the process of aspect 1, wherein in the providing step, the hydrogen comprises less than about 500 ppm by weight of water.

Aspect 9 is the process of aspect 1, wherein in the providing step, the iodine comprises less than about 500 ppm by weight of water.

Aspect 10 is the process of aspect 1, wherein in the providing step, the solvent comprises less than about 500 ppm by weight of water.

Aspect 11 is the process of any of aspects 1-10, wherein in the providing step, a mole ratio of the hydrogen to the iodine in the reaction stream is from about 1:1 to about 10:1.

Aspect 12 is the process of aspect 11, wherein the mole ratio of the hydrogen to the iodine in the reaction stream is from about 2.5:1 to about 3:1.

Aspect 13 is the process of aspect 1, wherein in the reacting step, a contact time of the reactant stream with the catalyst is from about 0.1 second to about 1,800 seconds.

Aspect 14 is the process of any of aspects 1-13, further comprising heating the reactant stream in a preheater to a temperature from about 180° C. to about 210° C. before the reacting step.

Aspect 15 is the process of any of aspects 1-14, further comprising heating the reactant stream to a temperature from about 300° C. to about 600° C. before the reacting step.

Aspect 16 is the process of any of aspects 1-15, wherein the process is a continuous process.

Aspect 17 is the process of any of aspects 1-16, wherein the product stream further comprises unreacted hydrogen and the process further comprises the additional steps of separating the hydrogen from the product stream and returning the separated hydrogen to the reactant stream.

Aspect 18 is a process for producing hydrogen iodide, the process comprising the steps of reacting hydrogen and iodine, the iodine dissolved in a solvent, in the presence of a catalyst to produce a product stream comprising hydrogen iodide, unreacted hydrogen, and dissolved unreacted iodine; removing at least some of the dissolved unreacted iodine from the product stream by cooling the product stream to collect the dissolved unreacted iodine; and recycling the dissolved iodine to the reacting step.

Aspect 19 is the process of aspect 18, wherein the solvent comprises at least one selected from the group of diethyl ether, diglyme, benzonitrile, acetonitrile, dimethylformamide, 1-ethyl-3-methylimidazolium acetate, sulfolane, carbon disulfide, toluene, naphthalene, xylene, 2,2-dimethylbutane, cyclohexane, ethanol, perfluoroheptane, and mesitylene.

Aspect 20 is the process of aspect 18 or 19, wherein the catalyst comprises at least one of the group of platinum, palladium, nickel, cobalt, iron, nickel oxide, cobalt oxide, and iron oxide, and wherein the catalyst is supported on a support.

Aspect 21 is the process of any of aspects 18-20, wherein the catalyst is selected from platinum or palladium.

Aspect 22 is the process of any of aspects 18-21, wherein the support is selected from the group of activated carbon, silica gel, zeolite, silicon carbide, metal oxides, or combinations thereof.

Aspect 23 is the process of aspect 22, wherein the support is a metal oxide support, the metal oxide support including alumina, magnesium oxide, titanium oxide, zinc oxide, zirconia, chromia, and combinations thereof.

Aspect 24 is the process of aspect 23, wherein the support is alumina.

Aspect 25 is the process of any of aspects 18-24, wherein the product stream further comprises unreacted hydrogen and the process further comprises the additional steps of separating the hydrogen from the product stream and recycling the separated hydrogen to the reacting step.

Aspect 26 is the process of any of aspects 18-25, wherein the process is a continuous process.

1. A process for producing hydrogen iodide, the process comprising:
providing a reactant stream comprising hydrogen and iodine, the iodine dissolved in a solvent; and
reacting the reactant stream in the presence of a catalyst to produce a product stream comprising hydrogen iodide.

2. The process of claim 1, wherein in the providing step, the solvent comprises at least one selected from the group of diethyl ether, diglyme, benzonitrile, acetonitrile, dimethylformamide, 1-ethyl-3-methylimidazolium acetate, sulfolane, carbon disulfide, toluene, naphthalene, xylene, 2,2-dimethylbutane, cyclohexane, ethanol, perfluoroheptane, and mesitylene.

3. The process of claim 1, wherein in the providing step, the catalyst comprises at least one of the group of platinum, palladium, nickel, cobalt, iron, nickel oxide, cobalt oxide, and iron oxide, and wherein the catalyst is supported on a support.

4. The process of claim 1, wherein the support is selected from the group of activated carbon, silica gel, zeolite, silicon carbide, metal oxides, or combinations thereof.

5. The process of claim 4, wherein the support is a metal oxide support, the metal oxide support including alumina, magnesium oxide, titanium oxide, zinc oxide, zirconia, chromia, and combinations thereof.

6. The process of claim 5, wherein the catalyst is selected from platinum on an alumina support or palladium on an alumina support.

7. The process of claim 3, wherein the catalyst is from about 0.03 wt. % to about 50 wt. % of the total weight of the catalyst and the support.

8. The process of claim 1, wherein in the providing step, the hydrogen comprises less than about 500 ppm by weight of water.

9. The process of claim 1, wherein in the providing step, the iodine comprises less than about 500 ppm by weight of water.

10. The process of claim 1, wherein in the providing step, the solvent comprises less than about 500 ppm by weight of water.

11. The process of claim 1, wherein in the providing step, a mole ratio of the hydrogen to the iodine in the reaction stream is from about 1:1 to about 10:1.

12. The process of claim 11, wherein the mole ratio of the hydrogen to the iodine in the reaction stream is from about 2.5:1 to about 3:1.

13. The process of claim 1, further comprising heating the reactant stream in a preheater to a temperature from about 180° C. to about 210° C. before the reacting step

14. The process of claim 1, further comprising heating the reactant stream to a temperature from about 300° C. to about 600° C. before the reacting step.

15. The process of claim 1 wherein the process is a continuous process.

16. A process for producing hydrogen iodide, the process comprising the following steps:
reacting hydrogen and iodine, the iodine dissolved in a solvent, in the presence of a catalyst to produce a product stream comprising hydrogen iodide, unreacted hydrogen, and dissolved unreacted iodine;
removing at least some of the dissolved unreacted iodine from the product stream by cooling the product stream to collect the dissolved unreacted iodine; and
recycling the dissolved iodine to the reacting step.

17. The process of claim 16, wherein the product stream further comprises unreacted hydrogen and the process further comprises the additional steps of:
separating the hydrogen from the product stream; and
recycling the separated hydrogen to the reacting step.

18. The process of claim 16, wherein the process is a continuous process.

19. The process of claim 16, wherein the support is selected from the group of activated carbon, silica gel, zeolite, silicon carbide, metal oxides, or combinations thereof.

20. The process of claim 19, wherein the support is a metal oxide support, the metal oxide support including alumina, magnesium oxide, titanium oxide, zinc oxide, zirconia, chromia, and combinations thereof.
